(19) United States
(12) Patent Application Publication
(10) Pub. No.: US 2026/0119947 A1
(43) Pub. Date: Apr. 30, 2026

(54) VISUALIZING AND MANIPULATING QUANTUM COMPUTATIONS ACROSS MULTIPLE LAYERS OF ABSTRACTION OF A QUANTUM STACK

(71) Applicant: International Business Machines Corporation, Armonk, NY (US)

(72) Inventors: Derek Wang, New York, NY (US); Alireza Seif Tabrizi, Adelphi, MD (US); Pedro Rivero Ramirez, Long Island City, NY (US)

(21) Appl. No.: 18/787,471

(22) Filed: Jul. 29, 2024

(51) Int. Cl. G06N 10/60; G06N 10/70

(52) U.S. Cl. CPC G06N 10/60; G06N 10/70

(57) ABSTRACT

A method, system and computer program product for visualizing and manipulating quantum computations across multiple layers of abstraction of a quantum stack. A quantum algorithm is decomposed to nodes and edges between the nodes, where each of the nodes uses at least one layer of the layers of abstraction of the quantum stack. Furthermore, each node of the graphical visualization corresponds to a computational task. Upon decomposing the quantum algorithm to nodes and edges, such nodes and edges are displayed. An aspect of the quantum algorithm is modified in response to editing a setting of a node, such as editing a setting in a control panel associated with the node. By manipulating one or more of these settings, an aspect of the quantum algorithm (e.g., QPU time) is modified. In this manner, quantum calculations across multiple layers of abstraction of the quantum stack can be visualized and manipulated.

### TECHNICAL FIELD

The present disclosure relates generally to tools for visualizing quantum computations, and more particularly to visualizing and manipulating quantum computations across multiple layers of abstraction of a quantum stack.

### BACKGROUND

Utility scale quantum computing requires optimization across all layers of abstraction of a quantum stack. Utility scale quantum computing refers to computing that is capable of reliably and accurately solving meaningful problems that are prohibitive on a classical computer. Layers of abstraction of a quantum stack refer to visualizing complex operations of a quantum algorithm into simpler, manageable segments. For example, a high level layer may involve the quantum algorithm design; whereas, a low level layer may be directed to quantum gate operations and physical qubit manipulation, thereby enabling users to focus on specific aspects, such as specific aspects of the quantum algorithm, without needing detailed knowledge of the entire system.

There has been extensive effort to optimize utility scale quantum computing, such as utilizing workflows involving pulse-to-circuit or circuit-to-circuit executions on quantum hardware or workflows involving post-processing on classical hardware. Tools for visualizing and interacting with such workflows are key to designing, understanding, and manipulating such complex workflows. Unfortunately, current tools for visualizing and interacting with such workflows are deficient.

For example, it has been attempted to use Qiskit® Patterns for visualizing and interacting with such workflows. Qiskit® Patterns are a four-step process for running algorithms on a quantum computer, which are used for describing utility-scale quantum computations, such as (1) mapping the problem to a quantum circuit; (2) optimizing the circuit for execution; (3) execution; and (4) post-processing.

Unfortunately, the Qiskit® Patterns framework is linear spanning only specific layers of the quantum stack while developers need tools that span the entire quantum stack. Furthermore, the Qiskit® Patterns framework is simply a 4-step plan without any visualization.

In another example, Qermit, an open-source Python® package, is utilized to visually graph quantum error mitigation as well as the workflow. However, quantum error mitigation is a specific layer of abstraction within the utility-scale quantum computation of the quantum stack. That is, the design (visualization of Qermit) lacks sufficient generality to all the abstraction layers of the quantum stack. Furthermore, such a design lacks the ability for two-way interaction between the output graph and the user.

Consequently, there is not currently a means for effectively visualizing and manipulating quantum computations across multiple layers of abstraction of the quantum stack.

### SUMMARY

In one embodiment of the present disclosure, a method for visualizing and manipulating quantum computations across multiple layers of abstraction of a quantum stack comprises receiving a quantum algorithm. The method further comprises decomposing the quantum algorithm to nodes and edges between the nodes, where each of the nodes uses at least one layer of a plurality of layers of abstraction of the quantum stack. The method additionally comprises displaying the nodes and the edges between the nodes. Furthermore, the method comprises modifying an aspect of the quantum algorithm in response to editing a setting of a node.

Furthermore, in one embodiment of the present disclosure, the nodes correspond to computational tasks, where the edges define relationships between the nodes.

Additionally, in one embodiment of the present disclosure, the nodes provide one or more of the following information in the group consisting of: a stage, an estimated time of computation, and a method of random sampling, where the edges provide one or more of the following information in the group consisting of: expected contribution to error or expectation value, measurement basis, logical dependency, and bitstring in a quantum error correction cycle.

Furthermore, in one embodiment of the present disclosure, one or more of the nodes correspond to nodes that comprise one or more sub-nodes at a lower level of abstraction of the quantum stack.

Additionally, in one embodiment of the present disclosure, each of the one or more sub-nodes is associated with encoded information, where the encoded information comprises information regarding whether the sub-node can be expanded.

Furthermore, in one embodiment of the present disclosure, settings in sub-node level i are consistent across level i-1.

Additionally, in one embodiment of the present disclosure, the settings are defined in a control panel.

Furthermore, in one embodiment of the present disclosure, the plurality of layers of abstraction of the quantum stack comprise the following in the group consisting of: an application layer, an algorithm layer, a framework layer, an architecture layer, a control logic layer, a circuit layer, and a hardware layer.

Other forms of the embodiments of the method described above are in a system and in a computer program product.

Accordingly, embodiments of the present disclosure enable visualization and manipulation of quantum calculations across multiple layers of abstraction of the quantum stack. As a result, the structure of quantum computational workflows is accommodated. Furthermore, developers at any level, from device physicist to quantum computational scientist to software developer to end-user, can utilize this tool. That is, various developers can utilize the tool of the present disclosure across all layers of abstraction of the quantum stack which will accelerate understanding, modification, and debugging of large-scale quantum computations.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for visualizing and manipulating quantum calculations across multiple layers of abstraction of the quantum stack in accordance with an embodiment of the present disclosure;

FIG. 3 illustrates the layers of abstraction of a quantum stack in accordance with an embodiment of the present disclosure;

FIG. 4 illustrates displaying the nodes and edges of the decomposed quantum algorithm in accordance with an embodiment of the present disclosure;

FIG. 5 illustrates a control panel for defining the settings for the nodes across the lower level abstraction layer of the node/sub-node in accordance with an embodiment of the present disclosure;

FIG. 6 illustrates visualizing the nodes and edges of a decomposed quantum algorithm with the computational task of finding the best drug candidate in accordance with an embodiment of the present disclosure;

FIG. 7 illustrates integrating the visualization of the quantum computations across multiple layers of abstraction of a quantum stack with the visualization of the dynamic quantum circuit's layers over time in accordance with an embodiment of the present disclosure;

FIG. 8 illustrates an embodiment of the present disclosure of the hardware configuration of the classical computer which is representative of a hardware environment for practicing the present disclosure; and

FIG. 9 is a flowchart of a method for visualizing and manipulating quantum calculations across multiple layers of abstraction of the quantum stack in accordance with an embodiment of the present disclosure.

### DETAILED DESCRIPTION

In one embodiment of the present disclosure, a method for visualizing and manipulating quantum computations across multiple layers of abstraction of a quantum stack comprises receiving a quantum algorithm. The method further comprises decomposing the quantum algorithm to nodes and edges between the nodes, where each of the nodes uses at least one layer of a plurality of layers of abstraction of the quantum stack. The method additionally comprises displaying the nodes and the edges between the nodes. Furthermore, the method comprises modifying an aspect of the quantum algorithm in response to editing a setting of a node.

In this manner, quantum calculations across multiple layers of abstraction of the quantum stack can be visualized and manipulated. As a result, the structure of quantum computational workflows is accommodated. Furthermore, developers at any level, from device physicist to quantum computational scientist to software developer to end-user, can utilize this tool. That is, various developers can utilize the tool of the present disclosure across all layers of abstraction of the quantum stack which will accelerate understanding, modification, and debugging of large-scale quantum computations.

Furthermore, in one embodiment of the present disclosure, the nodes correspond to computational tasks, where the edges define relationships between the nodes.

In this manner, quantum computational workflows can be graphically visualized.

Additionally, in one embodiment of the present disclosure, the nodes provide one or more of the following information in the group consisting of: a stage, an estimated time of computation, and a method of random sampling, where the edges provide one or more of the following information in the group consisting of: expected contribution to error or expectation value, measurement basis, logical dependency, and bitstring in a quantum error correction cycle.

In this manner, quantum computational workflows can be graphically visualized in a manner that enables the interaction and manipulation of the quantum computational workflow.

Furthermore, in one embodiment of the present disclosure, one or more of the nodes correspond to nodes that comprise one or more sub-nodes at a lower level of abstraction of the quantum stack.

In this manner, quantum computational workflows can be graphically visualized in a manner that enables the interaction and manipulation of the quantum computational workflow.

Additionally, in one embodiment of the present disclosure, each of the one or more sub-nodes is associated with encoded information, where the encoded information comprises information regarding whether the sub-node can be expanded.

In this manner, quantum computational workflows can be graphically visualized in a manner that enables the interaction and manipulation of the quantum computational workflow.

Furthermore, in one embodiment of the present disclosure, settings in sub-node level i are consistent across level i-1.

In this manner, an aspect of the quantum algorithm can be modified in response to editing a setting of a node/sub-node.

Additionally, in one embodiment of the present disclosure, the settings are defined in a control panel.

In this manner, an aspect of the quantum algorithm can be modified in a user-friendly manner.

Furthermore, in one embodiment of the present disclosure, the plurality of layers of abstraction of the quantum stack comprise the following in the group consisting of: an application layer, an algorithm layer, a framework layer, an architecture layer, a control logic layer, a circuit layer, and a hardware layer.

In this manner, the structure of quantum computational workflows is accommodated.

Other forms of the embodiments of the method described above are in a system and in a computer program product.

As stated above, utility scale quantum computing requires optimization across all layers of abstraction of a quantum stack. Utility scale quantum computing refers to computing that is capable of reliably and accurately solving meaningful problems that are prohibitive on a classical computer. Layers of abstraction of a quantum stack refer to visualizing complex operations of a quantum algorithm into simpler, manageable segments. For example, a high level layer may involve the quantum algorithm design; whereas, a low level layer may be directed to quantum gate operations and physical qubit manipulation, thereby enabling users to focus on specific aspects, such as specific aspects of the quantum algorithm, without needing detailed knowledge of the entire system.

There has been extensive effort to optimize utility scale quantum computing, such as utilizing workflows involving pulse-to-circuit or circuit-to-circuit executions on quantum hardware or workflows involving post-processing on classical hardware. Tools for visualizing and interacting with such workflows are key to designing, understanding, and manipulating such complex workflows. Unfortunately, current tools for visualizing and interacting with such workflows are deficient.

For example, it has been attempted to use Qiskit® Patterns for visualizing and interacting with such workflows. Qiskit® Patterns are a four-step process for running algorithms on a quantum computer, which are used for describing utility-scale quantum computations, such as (1) mapping the problem to a quantum circuit; (2) optimizing the circuit for execution; (3) execution; and (4) post-processing.

Unfortunately, the Qiskit® Patterns framework is linear spanning only specific layers of the quantum stack while developers need tools that span the entire quantum stack. Furthermore, the Qiskit® Patterns framework is simply a 4-step plan without any visualization.

In another example, Qermit, an open-source Python® package, is utilized to visually graph quantum error mitigation as well as the workflow. However, quantum error mitigation is a specific layer of abstraction within the utility-scale quantum computation of the quantum stack. That is, the design (visualization of Qermit) lacks sufficient generality to all the abstraction layers of the quantum stack. Furthermore, such a design lacks the ability for two-way interaction between the output graph and the user.

Consequently, there is not currently a means for effectively visualizing and manipulating quantum computations across multiple layers of abstraction of the quantum stack.

The embodiments of the present disclosure provide the means for visualizing and manipulating quantum calculations across multiple layers of abstraction of the quantum stack. In one embodiment, a graph-based visualization of the workflow of the quantum algorithm is generated which includes nodes and sub-nodes (child nodes, such as a node within another node in a graphical visualization) corresponding to computational tasks. Each of the nodes and sub-nodes use at least one layer of the layers of abstraction of the quantum stack. The layers of abstraction of the quantum stack, as used herein, refer to visualizing complex operations of a quantum algorithm into simpler, manageable segments. For example, a high level layer may involve the quantum algorithm design; whereas, a low level layer may be directed to quantum gate operations and physical qubit manipulation, thereby enabling users to focus on specific aspects, such as specific aspects of the quantum algorithm, without needing detailed knowledge of the entire system. For instance, the layers of abstraction of the quantum stack may include an application layer, an algorithm layer, a framework layer, an architecture layer, a control logic layer, a circuit layer, and a hardware layer. In one embodiment, the settings of each node or sub-node is defined in a control panel, which is accessible by a user selecting the node or sub-node. In one embodiment, the settings of a node/sub-node at level i are consistent across level i-1. As a result, in response to editing a setting of a node/sub-node, an aspect of the quantum algorithm is modified. For example, a setting of the control panel may correspond to the measurement basis or the number of shots. Upon editing the setting of the control panel, the workflow metrics are automatically updated, such as in a dashboard. For example, workflow metrics, such as expected execution time and estimation error, may be updated. In this manner, a tool has been developed for visualizing and manipulating quantum calculations across multiple layers of abstraction of the quantum stack by visualizing nodes/sub-nodes corresponding to computational tasks and enabling the interaction and manipulation of the workflow. These and other features will be discussed in further detail below.

In some embodiments of the present disclosure, the present disclosure comprises a method, system and computer program product for visualizing and manipulating quantum computations across multiple layers of abstraction of a quantum stack. In one embodiment of the present disclosure, a quantum algorithm is decomposed to nodes and edges between the nodes, where each of the nodes uses at least one layer of the layers of abstraction of the quantum stack. A “node,” as used herein, refers to the fundamental unit that makes up the graphical visualization of the workflow of the quantum algorithm. In particular, nodes, as used herein, refer to the objects that are connected to each other by edges in a graph diagram. Nodes may be represented by circles with labels and edges are represented by lines or arrows that extend from one node to another node. A “sub-node,” as used herein, refers to a child node, such as a node within another node in a graphical visualization. In one embodiment, each node of the graphical visualization may include zero or one or more sub-nodes. In one embodiment, each node/sub-node corresponds to a computational task. An “edge,” as used herein, refers to the lines or arrows that connect one node to another node. In one embodiment, a received quantum algorithm is decomposed to nodes and edges between the nodes by performing unitary decomposition, which maps the quantum algorithm to an arbitrary set of gates. Efficient implementation of this decomposition allows for the translation of unitary gates into elementary quantum operations (computational tasks), which are associated with nodes in a graphical visualization. Upon decomposing the quantum algorithm to nodes and edges, such nodes and edges are displayed. An aspect of the quantum algorithm is modified in response to editing a setting of a node, such as editing a setting in a control panel associated with the node. In one embodiment, the settings in the control panel are consistent across the next lower level abstraction layer. By manipulating one or more of these settings, an aspect of the quantum algorithm (e.g., QPU time) is modified by manipulating the settings associated with the sub-nodes of the next lower level abstraction layer. That is, an aspect of the quantum algorithm is modified in response to editing a setting of a node. In this manner, quantum calculations across multiple layers of abstraction of the quantum stack can be visualized and manipulated.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill the relevant art.

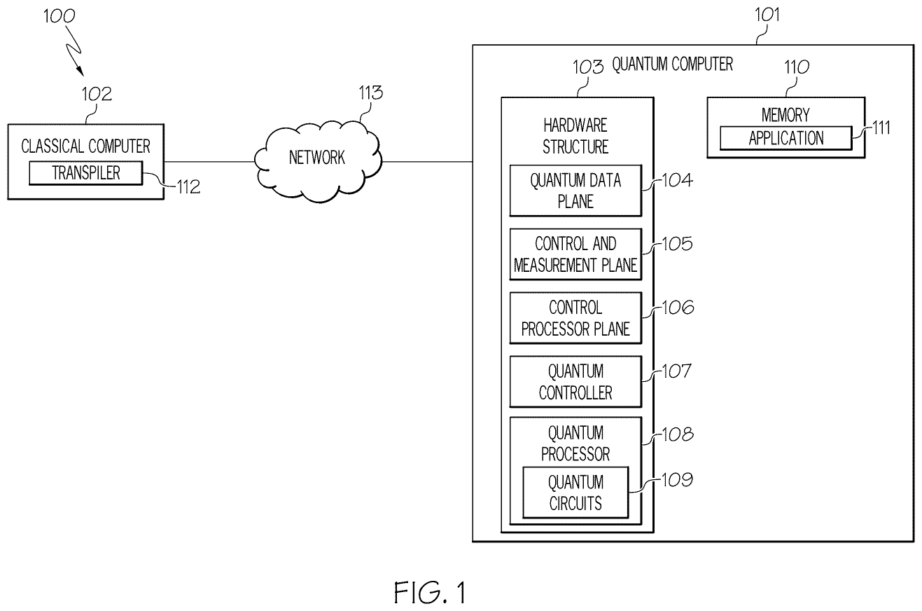

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to setup the state of quantum bits in quantum computer 101 and then quantum computer 101 starts the quantum process. Furthermore, in one embodiment, classical computer 102 is configured to visualize and manipulate quantum calculations across multiple layers of abstraction of the quantum stack as discussed further below.

In one embodiment, a hardware structure 103 of quantum computer 101 includes a quantum data plane 104, a control and measurement plane 105, a control processor plane 106, a quantum controller 107, and a quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (performs e^{iθX/2}, which corresponds to a rotation of the qubit state around the X-axis by the given angle theta θ on the Bloch sphere), RY (performs e^{iθY/2}, which corresponds to a rotation of the qubit state around the Y-axis by the given angle theta θ on the Bloch sphere), RXX (performs the operation e^{(-iθX}^{_{⊗}}^{X/2)} on the input qubit), RZZ (takes in one input, an angle theta θ expressed in radians, and it acts on two qubits), etc. In one embodiment, quantum circuits 109 are written such that the horizontal axis is time, starting at the left hand side and ending at the right hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 include memory 110, which may correspond to quantum memory. In one embodiment, memory 110 is a set of quantum bits that store quantum states for later retrieval. The state stored in quantum memory 110 can retain quantum superposition.

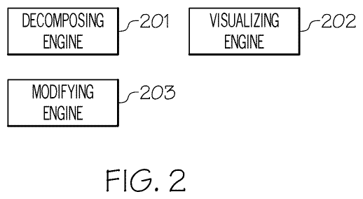

In one embodiment, memory 110 stores an application 111 that may be configured to implement one or more of the methods described herein in accordance with one or more embodiments. For example, application 111 may implement a program for visualizing and manipulating quantum calculations across multiple layers of abstraction of the quantum stack as discussed further below in connection with FIGS. 2-7 and 9. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit® is an open-source software development kit for working with quantum computers at the level of circuits, pulses, and algorithms) converts the trained machine learning model upon execution on quantum hardware 103 to its elementary instructions and maps it to physical qubits.

In one embodiment, quantum machine learning models are based on variational quantum circuits 109. Such models consist of data encoding, processing parameterized with trainable parameters, and measurement/post-processing.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to setup the state of quantum bits in quantum computer 101, may be connected to quantum computer 101 via a network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

Furthermore, classical computer 102 is configured to visualize and manipulate quantum calculations across multiple layers of abstraction of the quantum stack as discussed further below in connection with FIGS. 2-7 and 9. A description of the software components of classical computer 102 is provided below in connection with FIG. 2 and a description of the hardware configuration of classical computer 102 is provided further below in connection with FIG. 8.

System 100 is not to be limited in scope to any one particular network architecture. System 100 may include any number of quantum computers 101, classical computers 102, and networks 113.

A discussion regarding the software components used by classical computer 102 for visualizing and manipulating quantum calculations across multiple layers of abstraction of the quantum stack is provided below in connection with FIG. 2.

FIG. 2 is a diagram of the software components of classical system 102 (FIG. 1) for visualizing and manipulating quantum calculations across multiple layers of abstraction of the quantum stack in accordance with an embodiment of the present disclosure.

Referring to FIG. 2, in conjunction with FIG. 1, classical computer 102 includes a decomposing engine 201 configured to decompose a received quantum algorithm to nodes and edges between the nodes.

An “algorithm,” as used herein, is a step-by-step procedure to perform a computation or a sequence of computation tasks, where each step can be performed on a computer. A “quantum algorithm,” as used herein, refers to an algorithm in which at least one of the steps is distinctly quantum, such as superposition or entanglement. Quantum algorithms are algorithms that can be performed on a quantum computer, such as quantum computer 101.

In one embodiment, quantum algorithms are described by a quantum circuit that act on input qubits and terminates with a measurement. A quantum circuit consists of quantum gates, each of which acts on a finite number of qubits. In one embodiment, quantum algorithms are stated in other models of quantum computation, such as the Hamiltonian oracle model.

In one embodiment, quantum algorithms are received by decomposing engine 201 by the user inputting such quantum circuits and models into classical computer 102, such as via the QuantumCircuit class Qiskit®.

As discussed above, decomposing engine 201 decomposes the received quantum algorithm to nodes and edges between the nodes. A “node,” as used herein, refers to the fundamental unit that makes up the graphical visualization of the workflow of the quantum algorithm. In particular, nodes, as used herein, refer to the objects that are connected to each other by edges in a graph diagram. Nodes may be represented by circles with labels and edges are represented by lines or arrows that extend from one node to another node. A “sub-node,” as used herein, refers to a child node, such as a node within another node in a graphical visualization. In one embodiment, each node of the graphical visualization may include zero or one or more sub-nodes. It is noted that a sub-node may be referred to herein as simply a node when being described generically. In one embodiment, each node/sub-node corresponds to a computational task. An “edge,” as used herein, refers to the lines or arrows that connect one node to another node.

In one embodiment, decomposing engine 201 decomposes a received quantum algorithm to nodes and edges between the nodes by performing unitary decomposition, which maps the quantum algorithm to an arbitrary set of gates. Efficient implementation of this decomposition allows for the translation of unitary gates into elementary quantum operations (computational tasks), which are associated with nodes in a graphical visualization.

In one embodiment, decomposing engine 201 decomposes the received quantum algorithm to nodes and edges between the nodes by performing unitary decomposition using the Quantum Shannon Decomposition technique. In another embodiment, decomposing engine 201 decomposes the received quantum algorithm to nodes and edges between the nodes by performing unitary decomposition using Qubiter. In other embodiments, decomposing engine 201 uses the ZYZ decomposition technique, decomposing through unentangling of qubits, and decomposition with Givens rotations to perform unitary decomposition.

In one embodiment, decomposing engine 201 decomposes a received quantum algorithm to nodes and edges between the nodes using the cosine-sine decomposition algorithm in Qiskit®. In another embodiment, decomposing engine 201 uses a method (e.g., cirq.two_qubit_matrix_to_operations) in Cirq®, such as the KAK decomposition, to perform such decomposition. For example, the quantum algorithm may be decomposed into a series of computational tasks, which are represented by the nodes/sub-nodes.

Furthermore, such decomposition techniques performed by decomposing engine 201 associates each of the computational tasks represented by the nodes/sub-nodes with at least one abstraction layer of the quantum stack. Such an association indicates the layer of abstraction of the quantum stack used by the node/sub-node.

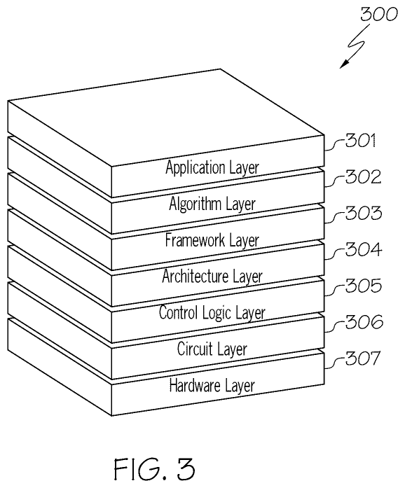

The layers of abstraction of the quantum stack, as used herein, refer to visualizing complex operations of a quantum algorithm into simpler, manageable segments. For example, a high level layer may involve the quantum algorithm design; whereas, a low level layer may be directed to quantum gate operations and physical qubit manipulation, thereby enabling users to focus on specific aspects, such as specific aspects of the quantum algorithm, without needing detailed knowledge of the entire system. For instance, a computation task to find the most stable drug enzyme combination may be associated with a high level of abstraction and a computation task to execute the specific circuit or pulse schedule may be associated with a low level of abstraction. An illustration of the layers of abstraction of the quantum stack is provided in FIG. 3.

Referring to FIG. 3, FIG. 3 illustrates the layers of abstraction of a quantum stack 300 in accordance with an embodiment of the present disclosure.

As shown in FIG. 3, quantum stack 300 includes an application layer 301 (e.g., development management, workflow management, sweeping parameters), an algorithm layer 302 (e.g., high level languages, subroutines, libraries), a framework layer 303 (e.g., circuit model and alternatives, optimizing compilers), an architecture layer 304 (e.g., quantum processing unit kernel, quantum error correction, quantum random access memory), a control logic layer 305 (e.g., pulse and timing calibration, decoding, error mitigation, such as noise stretching parameters in zero noise extrapolation, error correction, such as logical to physical encoding, error suppression, such as selecting different twirl sets), a circuit layer 306 (e.g., native gates, interconnections, placing dynamical decoupling pulses), and a hardware layer 307 (e.g., stretching pulses).

In one embodiment, decomposing engine 201 identifies the abstraction layer (e.g., abstraction layers 301-307) utilized by the nodes/sub-nodes based on the computational task represented by the nodes/sub-nodes. In one embodiment, decomposing engine 201 searches a data structure (e.g., table), which includes a listing of abstraction layers (e.g., abstraction layer 301) associated with computational tasks (e.g., workflow management). Upon identifying the computational task from decomposing the quantum algorithm, decomposing engine 201 identifies the abstraction layer (e.g., abstraction layer 301) associated with such a computational task in such a data structure. Furthermore, in one embodiment, such a data structure includes related sub-layers of abstraction. For example, abstraction layer 303 may be associated with abstraction layer 304 (abstraction layer below abstraction layer 303) as identified in such a data structure. In one embodiment, such a data structure resides within the storage device of classical computer 102. In one embodiment, such a data structure is populated by an expert.

As discussed above, unitary-scale quantum computation requires optimization across all layers of abstraction of quantum stack 300, such as abstraction layers 301-307.

Returning to FIG. 2, in conjunction with FIGS. 1 and 3, in one embodiment, such optimization is performed by obtaining critical information, which is encoded in the nodes and sub-nodes during the decomposition of the quantum algorithm. “Critical information,” as used herein, refers to information that is necessary to graphically visualize the quantum computational workflow and enable interaction and manipulation of the workflow. Examples of critical information include, but are not limited to, dependencies (e.g., logical dependency), ordering of execution, layer(s) of abstraction, related sub-layer(s) of abstraction, measurement basis, number of shots, a stage of operation, an estimated time of computation, method of random sampling, expected contribution to error or expectation values, bitstring in quantum error correction cycle, resource cost, estimated error, etc. A “quantum computational workflow,” as used herein, refers to a specification of the computational tasks to be executed by the quantum algorithm and the relationships between such computational tasks.

In one embodiment, such critical information is obtained during the decomposition of the quantum algorithm. For example, dependencies (e.g., logical dependencies) are obtained by analyzing structural dependencies. Other examples include analyzing the quantum circuit data to obtain the order of execution, such as via the QauntumCircuit.data of Qiskit®, analyzing a data structure to obtain the abstraction layer (e.g., abstraction layer 301) and related sub-layer(s) of abstraction associated with such a computational task as discussed above, measuring spin in a certain direction to obtain the measurement basis, such as by using the SpinCircuitSolver class of Qiskit®, obtaining the number of shots, such as by evaluating the results of a circuit execution stored in the Counts class in Qiskit®, obtaining a stage of operation (e.g., stage of Qiskit® Patterns), obtaining an estimated time of computation, such as via the queue_info( ) method of IBM®QJob, obtaining the method of random sampling, such as via the extended stabilizer method and the Sampler primitive in Qiskit®, obtaining the expected contribution to error or expectation values, such as via the Qiskit® Primitives Estimator class, obtaining the bitstring in the quantum error correction cycle, such as via the quantum error correction performed in Qiskit® (e.g., Shor code), obtaining the estimated error, such as via the Qiskit® Primitives Estimator class, etc.

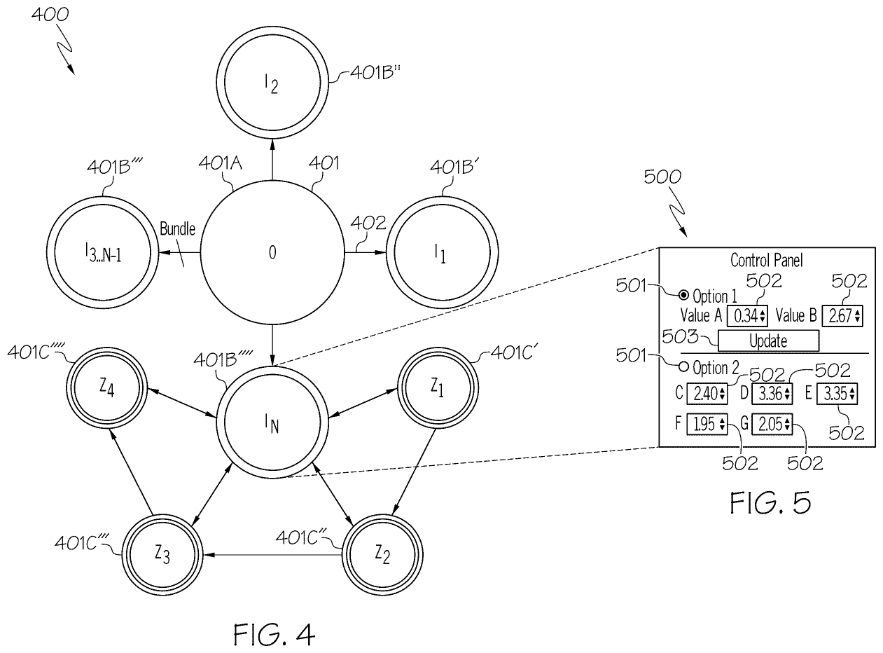

In one embodiment, such obtained critical information is represented graphically by visualizing engine 202 of classical computer 102. For example, in one embodiment, each node or sub-node of the decomposed quantum algorithm represents a computational task, where each node and sub-node uses at least one layer of abstraction of quantum stack 300. In one embodiment, each edge defines the relationships between the nodes, which represent computational tasks. An illustration of such a visualization is provided in FIG. 4.

Referring to FIG. 4, FIG. 4 illustrates displaying the nodes and edges of the decomposed quantum algorithm in accordance with an embodiment of the present disclosure.

As shown in FIG. 4, visualizing engine 202 displays a visualization 400 of the nodes 401 and the edges 402 between nodes 401 of the decomposed algorithm. In one embodiment, nodes 401 are represented by circles in visualization 400. In one embodiment, nodes 401 correspond to computational tasks, where each of the nodes 401 uses at least one layer of abstraction (e.g., abstraction layer 301) of quantum stack 300. In one embodiment, visualizing engine 202 depicts the abstraction layer utilized by node 401 based on the number of circles of node 401. For example, node 401A is depicted as a single circle and hence uses abstraction layer 301 (application layer 301) of quantum stack 300.

In one embodiment, each node 401 may include zero or one or more sub-nodes, which use a lower level of abstraction (e.g., algorithm layer 302). For example, as illustrated in FIG. 4, node 401A (identified by “0” in FIG. 4) includes sub-nodes 401B′, 401B″, 401B′″ and 401B″″ (identified by “I₁, I_{2,} I_{3 . . . N-1,} such as via a bundle, and I_{N},” respectively, in FIG. 4). Such sub-nodes 401B′, 401B″, 401B′″ and 401B″″ are at a lower level of abstraction, such as abstraction layer 302, in comparison to the abstraction layer of node 401A (uses abstraction layer 301). In one embodiment, such a lower level of abstraction, such as abstraction layer 302, that is used by sub-nodes 401B′, 401B″, 401B′″ and 401B″″ is graphed by visualizing engine 202 by depicting two circles for nodes 401B′, 401B″, 401B′″ and 401B″″.

Similarly, sub-nodes 401B′, 401B″, 401B′″ and 401B″″ may include zero or one or more sub-nodes. For example, sub-node 401B″″ includes sub-nodes 401C′, 401C″, 401C′″ and 401C″″ (identified by “Z₁, Z_{2,} Z₃ and Z₄,” respectively, in FIG. 4). Such sub-nodes 401C′, 401C″, 401C′″ and 401C″″ are at a lower level of abstraction, such as abstraction layer 303, in comparison to the abstraction layer of node 401B″″ (uses abstraction layer 302). In one embodiment, such a lower level of abstraction, such as abstraction layer 303, that is used by sub-nodes 401C′, 401C″, 401C′″ and 401C″″ is graphed by visualizing engine 202 by depicting three circles for nodes 401C′, 401C″, 401C′″ and 401C″″.

Nodes 401A, 401B′, 401B″, 401B′″ and 401B″″, and 401C′, 401C″, 401C′″ and 401C″″ may collectively or individually be referred to as nodes 401 or node 401, respectively. It is noted that visualizing engine 202 may depict any number of nodes 401, including any number of sub-nodes at any number of lower levels of abstraction, in visualization 400.

Furthermore, in one embodiment, edges 402 between nodes 401 define the relationships between the connecting nodes 401, such as dependency.

In one embodiment, visualizing engine 202 encodes the critical information obtained by decomposing engine 201 pertaining to nodes 401 and edges 402 via colors, borders, shading, etc. For example, nodes 401 may be encoded with critical information, such as the stage (e.g., stage of Qiskit® Patterns), size or estimated time of computation, method of random sampling, etc. In another example, edges 402 may be encoded with critical information, such as the expected contribution to the error or expectation value, measurement basis, logical dependency, the bitstring in the quantum error correction cycle, etc.

In one embodiment, visualizing engine 202 encodes critical information, such as whether the sub-node (e.g., sub-node 401B″″) can be expanded. A node or sub-node can be expanded when there is there is a lower level abstraction layer associated with the node or sub-node.

In one embodiment, the settings in node/sub-node level i are consistent across level i-1 and are defined in a data structure referred to herein as the “control panel” as shown in FIG. 5.

FIG. 5 illustrates a control panel 500 for defining the settings for the nodes across the lower level abstraction layer of the node/sub-node in accordance with an embodiment of the present disclosure.

Referring to FIG. 5, control panel 500 includes the options 501 for updating a setting 502, such as via update icon 503. Since such settings 502 are consistent across the next lower level abstraction layer, the settings across the node's (or sub-node's) sub-nodes can be manipulated. Examples of settings 502 for a computational task associated with a high level abstraction layer (e.g., finding the most stable drug enzyme combination) may be the number of molecules to search or the metric for the most stable combination. Examples of settings 502 for a computational task associated with a low level abstraction layer (e.g., executing a specific circuit or pulse schedule) may be the measurement basis or the number of shots.

In one embodiment, manipulating settings in control panel 500 automatically updates the workflow metrics (e.g., expected execution time, estimated error), such as in a dashboard displayed to a user of classical computer 102. In one embodiment, settings 502 may be manipulated via code, radio buttons, sliders, etc. As discussed further below, an aspect of the quantum algorithm is modified in response to editing a setting of a node/sub-node, such as via update icon 503.

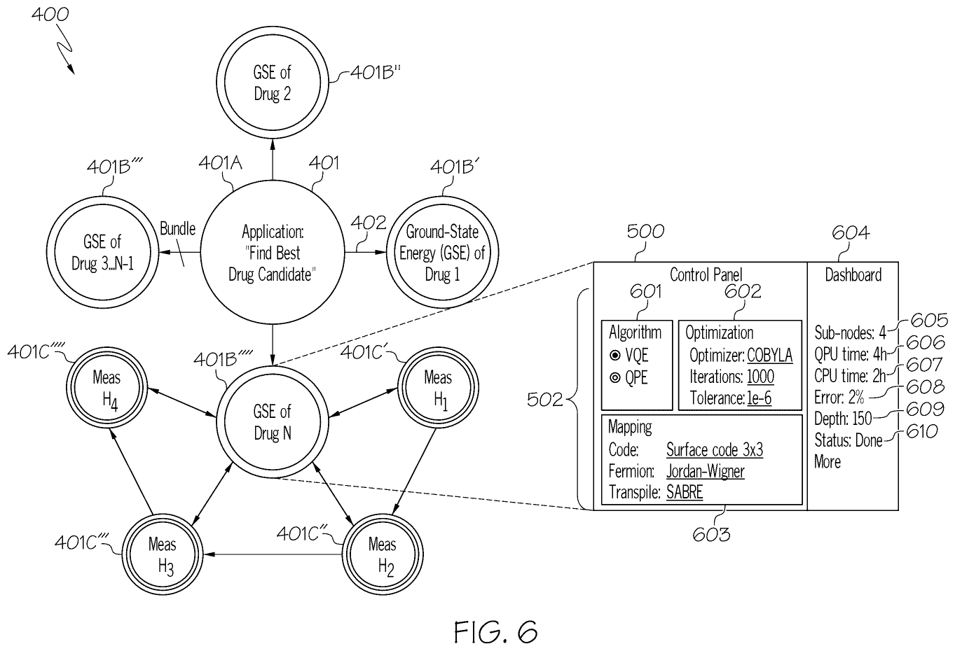

An example of visualizing the nodes and edges of a decomposed quantum algorithm is provided below in connection with FIG. 6.

FIG. 6 illustrates visualizing the nodes and edges of a decomposed quantum algorithm with the computational task of finding the best drug candidate in accordance with an embodiment of the present disclosure.

Referring to FIG. 6, the computational task at a high level of abstraction associated with node 401A is finding the best drug candidate. Node 401A includes sub-nodes 401B′, 401B″, 401B′″, and 401B″″ associated with the next lower abstraction layer. The computational tasks associated with sub-nodes 401B′, 401B″, 401B′″, and 401B″″ include the ground state energy (GSE) of drug 1, the GSE of drug 2, the GSE of drug 3 . . . N-1, such as via a bundle, and the GSE of drug N, respectively, as shown in FIG. 6. Furthermore, as illustrated in FIG. 6, the sub-nodes of node 401B″″ include sub-nodes 401C′, 401C″, 401C′″, and 401C″″. The computational tasks associated with sub-nodes 401C′, 401C″, 401C′″, and 401C″″ include the measurement (abbreviated as “Meas” in FIG. 6) of H₁, the measurement of H₂, the measurement of H₃, and the measurement of H₄, respectively, as shown in FIG. 6.

By a user selecting a node, such as node 401B″″, a control panel 500 may be visually displayed to the user, such as the user of classical computer 102, as shown in FIG. 6. As previously discussed, control panel 500 includes settings 502 that are consistent across all of the selected node's sub-nodes (e.g., 401C′, 401C″, 401C′″, and 401C″″), which can be manipulated. As illustrated in FIG. 6, example settings 502 include the option for selecting an algorithm 601 (e.g., variational quantum eigensolver (VQE) versus quantum phase estimation (QPE)), the type of optimization 602 (e.g., using the Constrained Optimization BY Linear Approximation (COBYLA) algorithm with 1,000 iterations along with a tolerance of 1e⁻⁶, and the type of mapping 603 (e.g., mapping using the Jordan-Wigner transformation that maps spin operators onto fermionic creation and annihilation operators using surface code (3×3) and using the SWAP-based BidiREctional (SABRE) heuristic search algorithm for transpilation.

As previously discussed, since settings 502, such as settings 601-603, are consistent across the next lower level abstraction layer, the settings across the node's (or sub-node's) sub-nodes, such as sub-nodes 401C′, 401C″, 401C′″, and 401C″″ of node 401B″″, can be manipulated.

In one embodiment, visualizing engine 202 updates the workflow metrics in a dashboard 604, which may be displayed to a user of classical computer 102, in response to the manipulation of the settings 502 (e.g., settings 601-603) in control panel 500, which applies to the node's (or sub-node's) sub-nodes, such as sub-nodes 401C′, 401C″, 401C′″, and 401C″″ of node 401B″″. An example of such a dashboard 604 is shown in FIG. 6 which includes the number of sub-nodes 605 (e.g., 4 sub-nodes), the quantum processing unit (QPU) time 606 (e.g., 4 hours), the central processing unit (CPU) time 607 (e.g., 2 hours), the estimated error 608 (e.g., 2%), the depth (the longest path in the quantum circuit) 609 (e.g., 150), status 610 (e.g., done), etc.

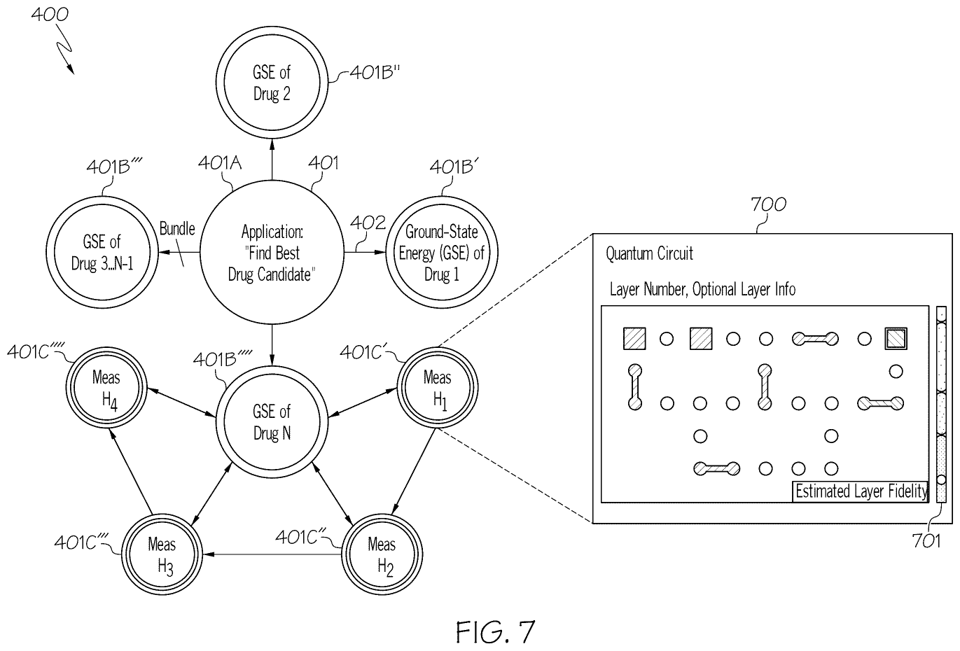

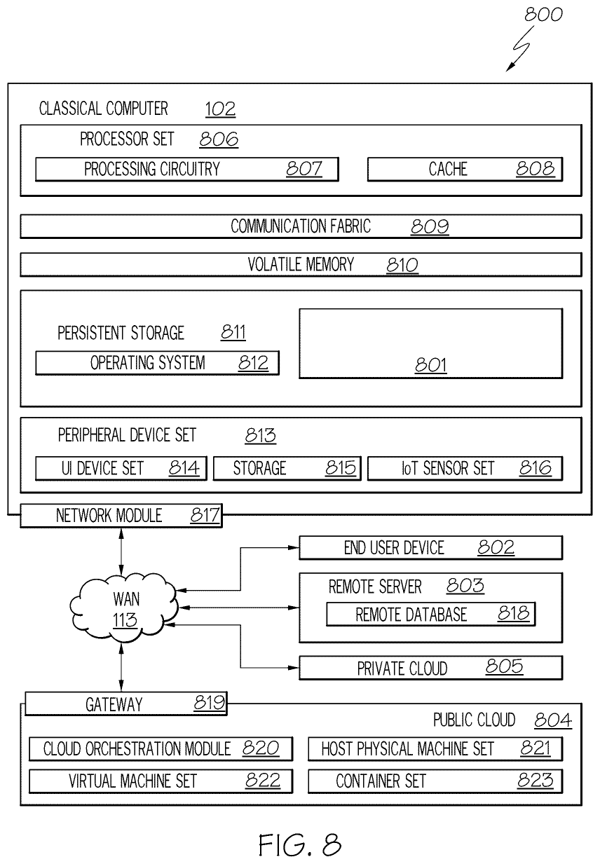

In one embodiment, the visualization of the quantum computations across multiple layers of abstraction of a quantum stack (e.g., quantum stack 300) may be integrated with the visualization of the dynamic quantum circuit's layers as illustrated in FIG. 7.

FIG. 7 illustrates integrating the visualization of the quantum computations across multiple layers of abstraction of a quantum stack with the visualization of the dynamic quantum circuit's layers over time in accordance with an embodiment of the present disclosure.

As shown in FIG. 7, the layers of a dynamic quantum circuit 700 can be visualized over time by scrolling through the quantum circuit's layers via a layer scroll 701. In one embodiment, layer scroll 701 includes color tags for depicting the various stages of the algorithms, such as the algorithms used for computing the ground state energy associated with nodes 401B′, 401B″, 401B′″, and 401B″″, or the algorithms used for computing the measurements associated with nodes 401C′, 401C″, 401C′″, and 401C″″. In one embodiment, at each layer, the depicted dynamic quantum circuit 700 includes the layer number and optional layer information, such as the estimated layer fidelity.

Returning to FIG. 2, in conjunction with FIGS. 5-6, classical computer 102 further includes modifying engine 203 configured to modify an aspect of the quantum algorithm in response to editing a setting of a node/sub-node, such as by editing a setting 502 in control panel 500.

As discussed above, settings 502 in control panel 500, such as settings 601-603, are consistent across the next lower level abstraction layer. By manipulating one or more of these settings, an aspect of the quantum algorithm (e.g., QPU time) is modified by manipulating the settings associated with the sub-nodes of the next lower level abstraction layer. That is, an aspect of the quantum algorithm is modified in response to editing a setting 502 of a node/sub-node, such as via update icon 503. In one embodiment, such modification of the quantum algorithm is implemented by modifying engine 203 using Qiskit®, such as by modifying the circuit model via the qiskit. circuit class.

In this manner, quantum calculations across multiple layers of abstraction of the quantum stack can be visualized and manipulated. As a result, the structure of quantum computational workflows is accommodated. Furthermore, developers at any level, from device physicist to quantum computational scientist to software developer to end-user, can utilize this tool. That is, various developers can utilize the tool of the present disclosure across all layers of abstraction of the quantum stack which will accelerate understanding, modification, and debugging of large-scale quantum computations.

A further description of these and other functions is provided below in connection with the discussion of the method for visualizing and manipulating quantum computations across multiple layers of abstraction of a quantum stack.

Prior to the discussion of the method for visualizing and manipulating quantum computations across multiple layers of abstraction of a quantum stack, a description of the hardware configuration of classical computer 102 (FIG. 1) is provided below in connection with FIG. 8.

Referring now to FIG. 8, in conjunction with FIG. 1, FIG. 8 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code 801 involved in performing the inventive methods, such as visualizing and manipulating quantum computations across multiple layers of abstraction of a quantum stack. In addition to block 801, computing environment 800 includes, for example, classical computer 102, network 113, such as a wide area network (WAN), end user device (EUD) 802, remote server 803, public cloud 804, and private cloud 805. In this embodiment, classical computer 102 includes processor set 806 (including processing circuitry 807 and cache 808), communication fabric 809, volatile memory 810, persistent storage 811 (including operating system 812 and block 801, as identified above), peripheral device set 813 (including user interface (UI) device set 814, storage 815, and Internet of Things (IoT) sensor set 816), and network module 817. Remote server 803 includes remote database 818. Public cloud 804 includes gateway 819, cloud orchestration module 820, host physical machine set 821, virtual machine set 822, and container set 823.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 818. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically classical computer 102, to keep the presentation as simple as possible. Classical computer 102 may be located in a cloud, even though it is not shown in a cloud in FIG. 8. On the other hand, classical computer 102 is not required to be in a cloud except to any extent as may be affirmatively indicated.

Processor set 806 includes one, or more, computer processors of any type now known or to be developed in the future. Processing circuitry 807 may be distributed over multiple packages, for example, multiple, coordinated integrated circuit chips. Processing circuitry 807 may implement multiple processor threads and/or multiple processor cores. Cache 808 is memory that is located in the processor chip package(s) and is typically used for data or code that should be available for rapid access by the threads or cores running on processor set 806. Cache memories are typically organized into multiple levels depending upon relative proximity to the processing circuitry. Alternatively, some, or all, of the cache for the processor set may be located “off chip.” In some computing environments, processor set 806 may be designed for working with qubits and performing quantum computing.

Computer readable program instructions are typically loaded onto classical computer 102 to cause a series of operational steps to be performed by processor set 806 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 808 and the other storage media discussed below. The program instructions, and associated data, are accessed by processor set 806 to control and direct performance of the inventive methods. In computing environment 800, at least some of the instructions for performing the inventive methods may be stored in block 801 in persistent storage 811.

Communication fabric 809 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 810 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 810 is located in a single package and is internal to classical computer 102, but, alternatively or additionally, the volatile memory may be distributed over multiple packages and/or located externally with respect to classical computer 102.

Persistent Storage 811 is any form of non-volatile storage for computers that is now known or to be developed in the future. The non-volatility of this storage means that the stored data is maintained regardless of whether power is being supplied to classical computer 102 and/or directly to persistent storage 811. Persistent storage 811 may be a read only memory (ROM), but typically at least a portion of the persistent storage allows writing of data, deletion of data and re-writing of data. Some familiar forms of persistent storage include magnetic disks and solid state storage devices. Operating system 812 may take several forms, such as various known proprietary operating systems or open source Portable Operating System Interface type operating systems that employ a kernel. The code included in block 801 typically includes at least some of the computer code involved in performing the inventive methods.

Peripheral device set 813 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 814 may include components such as a display screen, speaker, microphone, wearable devices (such as goggles and smart watches), keyboard, mouse, printer, touchpad, game controllers, and haptic devices. Storage 815 is external storage, such as an external hard drive, or insertable storage, such as an SD card. Storage 815 may be persistent and/or volatile. In some embodiments, storage 815 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 816 is made up of sensors that can be used in Internet of Things applications. For example, one sensor may be a thermometer and another sensor may be a motion detector.

Network module 817 is the collection of computer software, hardware, and firmware that allows classical computer 102 to communicate with other computers through WAN 113. Network module 817 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 817 are performed on the same physical hardware device. In other embodiments (for example, embodiments that utilize software-defined networking (SDN)), the control functions and the forwarding functions of network module 817 are performed on physically separate devices, such that the control functions manage several different network hardware devices. Computer readable program instructions for performing the inventive methods can typically be downloaded to classical computer 102 from an external computer or external storage device through a network adapter card or network interface included in network module 817.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 802 is any computer system that is used and controlled by an end user (for example, a customer of an enterprise that operates classical computer 102), and may take any of the forms discussed above in connection with classical computer 102. EUD 802 typically receives helpful and useful data from the operations of classical computer 102. For example, in a hypothetical case where classical computer 102 is designed to provide a recommendation to an end user, this recommendation would typically be communicated from network module 817 of classical computer 102 through WAN 113 to EUD 802. In this way, EUD 802 can display, or otherwise present, the recommendation to an end user. In some embodiments, EUD 802 may be a client device, such as thin client, heavy client, mainframe computer, desktop computer and so on.

Remote server 803 is any computer system that serves at least some data and/or functionality to classical computer 102. Remote server 803 may be controlled and used by the same entity that operates classical computer 102. Remote server 803 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 818 of remote server 803.

Public cloud 804 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 804 is performed by the computer hardware and/or software of cloud orchestration module 820. The computing resources provided by public cloud 804 are typically implemented by virtual computing environments that run on various computers making up the computers of host physical machine set 821, which is the universe of physical computers in and/or available to public cloud 804. The virtual computing environments (VCEs) typically take the form of virtual machines from virtual machine set 822 and/or containers from container set 823. It is understood that these VCEs may be stored as images and may be transferred among and between the various physical machine hosts, either as images or after instantiation of the VCE. Cloud orchestration module 820 manages the transfer and storage of images, deploys new instantiations of VCEs and manages active instantiations of VCE deployments. Gateway 819 is the collection of computer software, hardware, and firmware that allows public cloud 804 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 805 is similar to public cloud 804, except that the computing resources are only available for use by a single enterprise. While private cloud 805 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 804 and private cloud 805 are both part of a larger hybrid cloud.

Block 801 further includes the software components discussed above in connection with FIGS. 2-7 to visualize and manipulate quantum computations across multiple layers of abstraction of a quantum stack. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for visualizing and manipulating quantum computations across multiple layers of abstraction of a quantum stack, may be embodied in an application specific integrated circuit.

As stated above, utility scale quantum computing requires optimization across all layers of abstraction of a quantum stack. Utility scale quantum computing refers to computing that is capable of reliably and accurately solving meaningful problems that are prohibitive on a classical computer. Layers of abstraction of a quantum stack refer to visualizing complex operations of a quantum algorithm into simpler, manageable segments. For example, a high level layer may involve the quantum algorithm design; whereas, a low level layer may be directed to quantum gate operations and physical qubit manipulation, thereby enabling users to focus on specific aspects, such as specific aspects of the quantum algorithm, without needing detailed knowledge of the entire system. There has been extensive effort to optimize utility scale quantum computing, such as utilizing workflows involving pulse-to-circuit or circuit-to-circuit executions on quantum hardware or workflows involving post-processing on classical hardware. Tools for visualizing and interacting with such workflows are key to designing, understanding, and manipulating such complex workflows. Unfortunately, current tools for visualizing and interacting with such workflows are deficient. For example, it has been attempted to use Qiskit® Patterns for visualizing and interacting with such workflows. Qiskit® Patterns are a four-step process for running algorithms on a quantum computer, which are used for describing utility-scale quantum computations, such as (1) mapping the problem to a quantum circuit; (2) optimizing the circuit for execution; (3) execution; and (4) post-processing. Unfortunately, the Qiskit® Patterns framework is linear spanning only specific layers of the quantum stack while developers need tools that span the entire quantum stack. Furthermore, the Qiskit® Patterns framework is simply a 4-step plan without any visualization. In another example, Qermit, an open-source Python® package, is utilized to visually graph quantum error mitigation as well as the workflow. However, quantum error mitigation is a specific layer of abstraction within the utility-scale quantum computation of the quantum stack. That is, the design (visualization of Qermit) lacks sufficient generality to all the abstraction layers of the quantum stack. Furthermore, such a design lacks the ability for two-way interaction between the output graph and the user. Consequently, there is not currently a means for effectively visualizing and manipulating quantum computations across multiple layers of abstraction of the quantum stack.

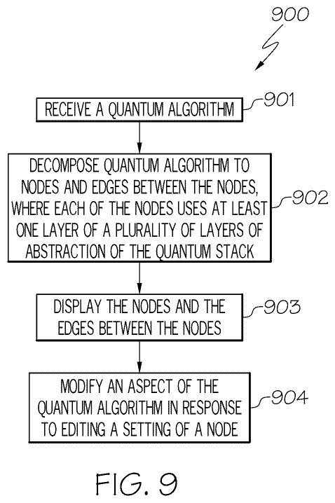

The embodiments of the present disclosure provide the means for visualizing and manipulating quantum calculations across multiple layers of abstraction of the quantum stack as discussed below in connection with FIG. 9.

FIG. 9 is a flowchart of a method 900 for visualizing and manipulating quantum calculations across multiple layers of abstraction of the quantum stack in accordance with an embodiment of the present disclosure.

Referring to FIG. 9, in conjunction with FIGS. 1-8, in step 901, decomposing engine 201 of classical computer 102 receives a quantum algorithm.

As discussed above, an “algorithm,” as used herein, is a step-by-step procedure to perform a computation or a sequence of computation tasks, where each step can be performed on a computer. A “quantum algorithm,” as used herein, refers to an algorithm in which at least one of the steps is distinctly quantum, such as superposition or entanglement. Quantum algorithms are algorithms that can be performed on a quantum computer, such as quantum computer 101.

In one embodiment, quantum algorithms are described by a quantum circuit that act on input qubits and terminates with a measurement. A quantum circuit consists of quantum gates, each of which acts on a finite number of qubits. In one embodiment, quantum algorithms are stated in other models of quantum computation, such as the Hamiltonian oracle model.

In one embodiment, quantum algorithms are received by decomposing engine 201 by the user inputting such quantum circuits and models into classical computer 102, such as via the QuantumCircuit class Qiskit®.

In step 902, decomposing engine 201 of classical computer 102 decomposes the received quantum algorithm to nodes and edges between the nodes, where each of the nodes uses at least one layer of a plurality of layers of abstraction (e.g., layers 301-307) of quantum stack 300.

As stated above, decomposing engine 201 decomposes the received quantum algorithm to nodes and edges between the nodes. A “node,” as used herein, refers to the fundamental unit that makes up the graphical visualization of the workflow of the quantum algorithm. In particular, nodes, as used herein, refer to the objects that are connected to each other by edges in a graph diagram. Nodes may be represented by circles with labels and edges are represented by lines or arrows that extend from one node to another node. A “sub-node,” as used herein, refers to a child node, such as a node within another node in a graphical visualization. In one embodiment, each node of the graphical visualization may include zero or one or more sub-nodes. It is noted that a sub-node may be referred to herein as simply a node when being described generically. In one embodiment, each node/sub-node corresponds to a computational task. An “edge,” as used herein, refers to the lines or arrows that connect one node to another node.

In one embodiment, decomposing engine 201 decomposes a received quantum algorithm to nodes and edges between the nodes by performing unitary decomposition, which maps the quantum algorithm to an arbitrary set of gates. Efficient implementation of this decomposition allows for the translation of unitary gates into elementary quantum operations (computational tasks), which are associated with nodes in a graphical visualization.

In one embodiment, decomposing engine 201 decomposes the received quantum algorithm to nodes and edges between the nodes by performing unitary decomposition using the Quantum Shannon Decomposition technique. In another embodiment, decomposing engine 201 decomposes the received quantum algorithm to nodes and edges between the nodes by performing unitary decomposition using Qubiter. In other embodiments, decomposing engine 201 uses the ZYZ decomposition technique, decomposing through unentangling of qubits, and decomposition with Givens rotations to perform unitary decomposition.

In one embodiment, decomposing engine 201 decomposes a received quantum algorithm to nodes and edges between the nodes using the cosine-sine decomposition algorithm in Qiskit®. In another embodiment, decomposing engine 201 uses a method (e.g., cirq.two_qubit_matrix_to_operations) in Cirq®, such as the KAK decomposition, to perform such decomposition. For example, the quantum algorithm may be decomposed into a series of computational tasks, which are represented by the nodes/sub-nodes.

Furthermore, such decomposition techniques performed by decomposing engine 201 associates each of the computational tasks represented by the nodes/sub-nodes with at least one abstraction layer of the quantum stack. Such an association indicates the layer of abstraction of the quantum stack used by the node/sub-node.

The layers of abstraction of the quantum stack, as used herein, refer to visualizing complex operations of a quantum algorithm into simpler, manageable segments. For example, a high level layer may involve the quantum algorithm design; whereas, a low level layer may be directed to quantum gate operations and physical qubit manipulation, thereby enabling users to focus on specific aspects, such as specific aspects of the quantum algorithm, without needing detailed knowledge of the entire system. For instance, a computation task to find the most stable drug enzyme combination may be associated with a high level of abstraction and a computation task to execute the specific circuit or pulse schedule may be associated with a low level of abstraction. An illustration of the layers of abstraction of the quantum stack is provided in FIG. 3.

As shown in FIG. 3, quantum stack 300 includes an application layer 301 (e.g., development management, workflow management, sweeping parameters), an algorithm layer 302 (e.g., high level languages, subroutines, libraries), a framework layer 303 (e.g., circuit model and alternatives, optimizing compilers), an architecture layer 304 (e.g., quantum processing unit kernel, quantum error correction, quantum random access memory), a control logic layer 305 (e.g., pulse and timing calibration, decoding, error mitigation, such as noise stretching parameters in zero noise extrapolation, error correction, such as logical to physical encoding, error suppression, such as selecting different twirl sets), a circuit layer 306 (e.g., native gates, interconnections, placing dynamical decoupling pulses), and a hardware layer 307 (e.g., stretching pulses).

In one embodiment, decomposing engine 201 identifies the abstraction layer (e.g., abstraction layers 301-307) utilized by the nodes/sub-nodes based on the computational task represented by the nodes/sub-nodes. In one embodiment, decomposing engine 201 searches a data structure (e.g., table), which includes a listing of abstraction layers (e.g., abstraction layer 301) associated with computational tasks (e.g., workflow management). Upon identifying the computational task from decomposing the quantum algorithm, decomposing engine 201 identifies the abstraction layer (e.g., abstraction layer 301) associated with such a computational task in such a data structure. Furthermore, in one embodiment, such a data structure includes related sub-layers of abstraction. For example, abstraction layer 303 may be associated with abstraction layer 304 (abstraction layer below abstraction layer 303) as identified in such a data structure. In one embodiment, such a data structure resides within the storage device (e.g., storage device 811, 815) of classical computer 102. In one embodiment, such a data structure is populated by an expert.

In step 903, visualizing engine 202 of classical computer 102 displays the nodes and the edges between the nodes.

As discussed above, unitary-scale quantum computation requires optimization across all layers of abstraction of quantum stack 300, such as abstraction layers 301-307.

In one embodiment, such optimization is performed by obtaining critical information, which is encoded in the nodes and sub-nodes during the decomposition of the quantum algorithm. “Critical information,” as used herein, refers to information that is necessary to graphically visualize the quantum computational workflow and enable interaction and manipulation of the workflow. Examples of critical information include, but are not limited to, dependencies (e.g., logical dependency), ordering of execution, layer(s) of abstraction, related sub-layer(s) of abstraction, measurement basis, number of shots, a stage of operation, an estimated time of computation, method of random sampling, expected contribution to error or expectation values, bitstring in quantum error correction cycle, resource cost, estimated error, etc. A “quantum computational workflow,” as used herein, refers to a specification of the computational tasks to be executed by the quantum algorithm and the relationships between such computational tasks.

In one embodiment, such critical information is obtained during the decomposition of the quantum algorithm. For example, dependencies (e.g., logical dependencies) are obtained by analyzing structural dependencies. Other examples include analyzing the quantum circuit data to obtain the order of execution, such as via the QauntumCircuit.data of Qiskit®, analyzing a data structure to obtain the abstraction layer (e.g., abstraction layer 301) and related sub-layer(s) of abstraction associated with such a computational task as discussed above, measuring spin in a certain direction to obtain the measurement basis, such as by using the SpinCircuitSolver class of Qiskit®, obtaining the number of shots, such as by evaluating the results of a circuit execution stored in the Counts class in Qiskit®, obtaining a stage of operation (e.g., stage of Qiskit® Patterns), obtaining an estimated time of computation, such as via the queue_info( ) method of IBM®QJob, obtaining the method of random sampling, such as via the extended stabilizer method and the Sampler primitive in Qiskit®, obtaining the expected contribution to error or expectation values, such as via the Qiskit® Primitives Estimator class, obtaining the bitstring in the quantum error correction cycle, such as via the quantum error correction performed in Qiskit® (e.g., Shor code), obtaining the estimated error, such as via the Qiskit® Primitives Estimator class, etc.

In one embodiment, such obtained critical information is represented graphically by visualizing engine 202 of classical computer 102. For example, in one embodiment, each node or sub-node of the decomposed quantum algorithm represents a computational task, where each node and sub-node uses at least one layer of abstraction of quantum stack 300. In one embodiment, each edge defines the relationships between the nodes, which represent computational tasks. An illustration of such a visualization is provided in FIG. 4.

As shown in FIG. 4, visualizing engine 202 displays a visualization 400 of the nodes 401 and the edges 402 between nodes 401 of the decomposed algorithm. In one embodiment, nodes 401 are represented by circles in visualization 400. In one embodiment, nodes 401 correspond to computational tasks, where each of the nodes 401 uses at least one layer of abstraction (e.g., abstraction layer 301) of quantum stack 300. In one embodiment, visualizing engine 202 depicts the abstraction layer utilized by node 401 based on the number of circles of node 401. For example, node 401A is depicted as a single circle and hence uses abstraction layer 301 (application layer 301) of quantum stack 300.

In one embodiment, each node 401 may include zero or one or more sub-nodes, which use a lower level of abstraction (e.g., algorithm layer 302). For example, as illustrated in FIG. 4, node 401A (identified by “0” in FIG. 4) includes sub-nodes 401B , 401B″, 401B′″ and 401B″″ (identified by “I₁, I_{2,} I_{3 . . . N-1,} such as via a bundle, and I_{N,}” respectively, in FIG. 4). Such sub-nodes 401B′, 401B″, 401B′″ and 401B″″ are at a lower level of abstraction, such as abstraction layer 302, in comparison to the abstraction layer of node 401A (uses abstraction layer 301). In one embodiment, such a lower level of abstraction, such as abstraction layer 302, that is used by sub-nodes 401B′, 401B″, 401B′″ and 401B″″ is graphed by visualizing engine 202 by depicting two circles for nodes 401B′, 401B″, 401B′″ and 401B″″.

Similarly, sub-nodes 401B′, 401B″, 401B′″ and 401B″″ may include zero or one or more sub-nodes. For example, sub-node 401B″″ includes sub-nodes 401C′, 401C″, 401C′″ and 401C″″ (identified by “Z₁, Z_{2,} Z_{3,} and Z₄,” respectively, in FIG. 4). Such sub-nodes 401C′, 401C″, 401C′″ and 401C″″ are at a lower level of abstraction, such as abstraction layer 303, in comparison to the abstraction layer of node 401B″″ (uses abstraction layer 302). In one embodiment, such a lower level of abstraction, such as abstraction layer 303, that is used by sub-nodes 401C′, 401C″, 401C′″ and 401C″″ is graphed by visualizing engine 202 by depicting three circles for nodes 401C′, 401C″, 401C′″ and 401C″″.

Furthermore, in one embodiment, edges 402 between nodes 401 define the relationships between the connecting nodes 401, such as dependency.

In one embodiment, visualizing engine 202 encodes the critical information obtained by decomposing engine 201 pertaining to nodes 401 and edges 402 via colors, borders, shading, etc. For example, nodes 401 may be encoded with critical information, such as the stage (e.g., stage of Qiskit® Patterns), size or estimated time of computation, method of random sampling, etc. In another example, edges 402 may be encoded with critical information, such as the expected contribution to the error or expectation value, measurement basis, logical dependency, the bitstring in the quantum error correction cycle, etc.

In one embodiment, visualizing engine 202 encodes critical information, such as whether the sub-node (e.g., sub-node 401B″″) can be expanded. A node or sub-node can be expanded when there is there is a lower level abstraction layer associated with the node or sub-node.

In one embodiment, the settings in node/sub-node level i are consistent across level i-1 and are defined in a data structure referred to herein as the “control panel”as shown in FIG. 5.

Referring to FIG. 5, control panel 500 includes the options 501 for updating a setting 502, such as via update icon 503. Since such settings 502 are consistent across the next lower level abstraction layer, the settings across the node's (or sub-node's) sub-nodes can be manipulated. Examples of settings 502 for a computational task associated with a high level abstraction layer (e.g., finding the most stable drug enzyme combination) may be the number of molecules to search or the metric for the most stable combination. Examples of settings 502 for a computational task associated with a low level abstraction layer (e.g., executing a specific circuit or pulse schedule) may be the measurement basis or the number of shots.

In one embodiment, manipulating settings in control panel 500 automatically updates the workflow metrics (e.g., expected execution time, estimated error), such as in a dashboard displayed to a user of classical computer 102. In one embodiment, settings 502 may be manipulated via code, radio buttons, sliders, etc. As discussed further below, an aspect of the quantum algorithm is modified in response to editing a setting of a node/sub-node, such as via update icon 503.

An example of visualizing the nodes and edges of a decomposed quantum algorithm is provided below in connection with FIG. 6.

Referring to FIG. 6, the computational task at a high level of abstraction associated with node 401A is finding the best drug candidate. Node 401A includes sub-nodes 401B′, 401B″, 401B′″, and 401B″″ associated with the next lower abstraction layer. The computational tasks associated with sub-nodes 401B′, 401B″, 401B′″, and 401B″″ include the ground state energy (GSE) of drug 1, the GSE of drug 2, the GSE of drug 3 . . . N-1, such as via a bundle, and the GSE of drug N, respectively, as shown in FIG. 6. Furthermore, as illustrated in FIG. 6, the sub-nodes of node 401B″″ include sub-nodes 401C′, 401C″, 401C′″, and 401C″″. The computational tasks associated with sub-nodes 401C′, 401C″, 401C′″, and 401C″″ include the measurement (abbreviated as “Meas” in FIG. 6) of H₁, the measurement of H₂, the measurement of H₃, and the measurement of H₄, respectively, as shown in FIG. 6.

By a user selecting a node, such as node 401B″″, a control panel 500 may be visually displayed to the user, such as the user of classical computer 102, as shown in FIG. 6. As previously discussed, control panel 500 includes settings 502 that are consistent across all of the selected node's sub-nodes (e.g., 401C′, 401C″, 401C′″, and 401C″″), which can be manipulated. As illustrated in FIG. 6, example settings 502 include the option for selecting an algorithm 601 (e.g., variational quantum eigensolver (VQE) versus quantum phase estimation (QPE)), the type of optimization 602 (e.g., using the Constrained Optimization BY Linear Approximation (COBYLA) algorithm with 1,000 iterations along with a tolerance of 1e⁻⁶, and the type of mapping 603 (e.g., mapping using the Jordan-Wigner transformation that maps spin operators onto fermionic creation and annihilation operators using surface code (3×3) and using the SWAP-based BidiREctional (SABRE) heuristic search algorithm for transpilation.

As previously discussed, since settings 502, such as settings 601-603, are consistent across the next lower level abstraction layer, the settings across the node's (or sub-node's) sub-nodes, such as sub-nodes 401C′, 401C″, 401C′″, and 401C″″ of node 401B″″, can be manipulated.

In one embodiment, visualizing engine 202 updates the workflow metrics in a dashboard 604, which may be displayed to a user of classical computer 102, in response to the manipulation of the settings 502 (e.g., settings 601-603) in control panel 500, which applies to the node's (or sub-node's) sub-nodes, such as sub-nodes 401C′, 401C″, 401C′″, and 401C″″ of node 401B″″. An example of such a dashboard 604 is shown in FIG. 6 which includes the number of sub-nodes 605 (e.g., 4 sub-nodes), the quantum processing unit (QPU) time 606 (e.g., 4 hours), the central processing unit (CPU) time 607 (e.g., 2 hours), the estimated error 608 (e.g., 2%), the depth (the longest path in the quantum circuit) 609 (e.g., 150), status 610 (e.g., done), etc.

In one embodiment, the visualization of the quantum computations across multiple layers of abstraction of a quantum stack (e.g., quantum stack 300) may be integrated with the visualization of the dynamic quantum circuit's layers as illustrated in FIG. 7.

As shown in FIG. 7, the layers of a dynamic quantum circuit 700 can be visualized over time by scrolling through the quantum circuit's layers via a layer scroll 701. In one embodiment, layer scroll 701 includes color tags for depicting the various stages of the algorithms, such as the algorithms used for computing the ground state energy associated with nodes 401B′, 401B″, 401B′″, and 401B″″, or the algorithms used for computing the measurements associated with nodes 401C′, 401C″, 401C′″, and 401C″″. In one embodiment, at each layer, the depicted dynamic quantum circuit 700 includes the layer number and optional layer information, such as the estimated layer fidelity.

In step 904, modifying engine 203 of classical computer 102 modifies an aspect of the quantum algorithm in response to editing a setting of a node/sub-node, such as by editing a setting 502 in control panel 500.

As stated above, settings 502 in control panel 500, such as settings 601-603, are consistent across the next lower level abstraction layer. By manipulating one or more of these settings, an aspect of the quantum algorithm (e.g., QPU time) is modified by manipulating the settings associated with the sub-nodes of the next lower level abstraction layer. That is, an aspect of the quantum algorithm is modified in response to editing a setting 502 of a node/sub-node, such as via update icon 503. In one embodiment, such modification of the quantum algorithm is implemented by modifying engine 203 using Qiskit®, such as by modifying the circuit model via the qiskit. circuit class.

In this manner, quantum calculations across multiple layers of abstraction of the quantum stack can be visualized and manipulated. As a result, the structure of quantum computational workflows is accommodated. Furthermore, developers at any level, from device physicist to quantum computational scientist to software developer to end-user, can utilize this tool. That is, various developers can utilize the tool of the present disclosure across all layers of abstraction of the quantum stack which will accelerate understanding, modification, and debugging of large-scale quantum computations.

Furthermore, the principles of the present disclosure improve the technology or technical field involving tools for visualizing quantum computations.

As discussed above, utility scale quantum computing requires optimization across all layers of abstraction of a quantum stack. Utility scale quantum computing refers to computing that is capable of reliably and accurately solving meaningful problems that are prohibitive on a classical computer. Layers of abstraction of a quantum stack refer to visualizing complex operations of a quantum algorithm into simpler, manageable segments. For example, a high level layer may involve the quantum algorithm design; whereas, a low level layer may be directed to quantum gate operations and physical qubit manipulation, thereby enabling users to focus on specific aspects, such as specific aspects of the quantum algorithm, without needing detailed knowledge of the entire system. There has been extensive effort to optimize utility scale quantum computing, such as utilizing workflows involving pulse-to-circuit or circuit-to-circuit executions on quantum hardware or workflows involving post-processing on classical hardware. Tools for visualizing and interacting with such workflows are key to designing, understanding, and manipulating such complex workflows. Unfortunately, current tools for visualizing and interacting with such workflows are deficient. For example, it has been attempted to use Qiskit® Patterns for visualizing and interacting with such workflows. Qiskit® Patterns are a four-step process for running algorithms on a quantum computer, which are used for describing utility-scale quantum computations, such as (1) mapping the problem to a quantum circuit; (2) optimizing the circuit for execution; (3) execution; and (4) post-processing. Unfortunately, the Qiskit® Patterns framework is linear spanning only specific layers of the quantum stack while developers need tools that span the entire quantum stack. Furthermore, the Qiskit® Patterns framework is simply a 4-step plan without any visualization. In another example, Qermit, an open-source Python® package, is utilized to visually graph quantum error mitigation as well as the workflow. However, quantum error mitigation is a specific layer of abstraction within the utility-scale quantum computation of the quantum stack. That is, the design (visualization of Qermit) lacks sufficient generality to all the abstraction layers of the quantum stack. Furthermore, such a design lacks the ability for two-way interaction between the output graph and the user. Consequently, there is not currently a means for effectively visualizing and manipulating quantum computations across multiple layers of abstraction of the quantum stack.

Embodiments of the present disclosure improve such technology by decomposing a quantum algorithm to nodes and edges between the nodes, where each of the nodes uses at least one layer of the layers of abstraction of the quantum stack. A “node,” as used herein, refers to the fundamental unit that makes up the graphical visualization of the workflow of the quantum algorithm. In particular, nodes, as used herein, refer to the objects that are connected to each other by edges in a graph diagram. Nodes may be represented by circles with labels and edges are represented by lines or arrows that extend from one node to another node. A “sub-node,” as used herein, refers to a child node, such as a node within another node in a graphical visualization. In one embodiment, each node of the graphical visualization may include zero or one or more sub-nodes. In one embodiment, each node/sub-node corresponds to a computational task. An “edge,” as used herein, refers to the lines or arrows that connect one node to another node. In one embodiment, a received quantum algorithm is decomposed to nodes and edges between the nodes by performing unitary decomposition, which maps the quantum algorithm to an arbitrary set of gates. Efficient implementation of this decomposition allows for the translation of unitary gates into elementary quantum operations (computational tasks), which are associated with nodes in a graphical visualization. Upon decomposing the quantum algorithm to nodes and edges, such nodes and edges are displayed. An aspect of the quantum algorithm is modified in response to editing a setting of a node, such as editing a setting in a control panel associated with the node. In one embodiment, the settings in the control panel are consistent across the next lower level abstraction layer. By manipulating one or more of these settings, an aspect of the quantum algorithm (e.g., QPU time) is modified by manipulating the settings associated with the sub-nodes of the next lower level abstraction layer. That is, an aspect of the quantum algorithm is modified in response to editing a setting of a node. In this manner, quantum calculations across multiple layers of abstraction of the quantum stack can be visualized and manipulated. Furthermore, in this manner, there is an improvement in the technical field involving tools for visualizing quantum computations.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for visualizing and manipulating quantum computations across multiple layers of abstraction of a quantum stack, the method comprising:
receiving a quantum algorithm;
decomposing said quantum algorithm to nodes and edges between said nodes, wherein each of said nodes uses at least one layer of a plurality of layers of abstraction of said quantum stack;
displaying said nodes and said edges between said nodes; and
modifying an aspect of said quantum algorithm in response to editing a setting of a node.

2. The method as recited in claim 1, wherein said nodes correspond to computational tasks, wherein said edges define relationships between said nodes.

3. The method as recited in claim 2, wherein said nodes provide one or more of the following information in the group consisting of: a stage, an estimated time of computation, and a method of random sampling, wherein said edges provide one or more of the following information in the group consisting of: expected contribution to error or expectation value, measurement basis, logical dependency, and bitstring in a quantum error correction cycle.

4. The method as recited in claim 1, wherein one or more of said nodes correspond to nodes that comprise one or more sub-nodes at a lower level of abstraction of said quantum stack.

5. The method as recited in claim 4, wherein each of said one or more sub-nodes is associated with encoded information, wherein said encoded information comprises information regarding whether said sub-node can be expanded.

6. The method as recited in claim 4, wherein settings in sub-node level i are consistent across level i-1.

7. The method as recited in claim 6, wherein said settings are defined in a control panel.

8. The method as recited in claim 1, wherein said plurality of layers of abstraction of said quantum stack comprise the following in the group consisting of: an application layer, an algorithm layer, a framework layer, an architecture layer, a control logic layer, a circuit layer, and a hardware layer.

9. A computer program product for visualizing and manipulating quantum computations across multiple layers of abstraction of a quantum stack, the computer program product comprising one or more computer readable storage mediums having program code embodied therewith, the program code comprising programming instructions for:
receiving a quantum algorithm;
decomposing said quantum algorithm to nodes and edges between said nodes, wherein each of said nodes uses at least one layer of a plurality of layers of abstraction of said quantum stack;
displaying said nodes and said edges between said nodes; and
modifying an aspect of said quantum algorithm in response to editing a setting of a node.

10. The computer program product as recited in claim 9, wherein said nodes correspond to computational tasks, wherein said edges define relationships between said nodes.

11. The computer program product as recited in claim 10, wherein said nodes provide one or more of the following information in the group consisting of: a stage, an estimated time of computation, and a method of random sampling, wherein said edges provide one or more of the following information in the group consisting of: expected contribution to error or expectation value, measurement basis, logical dependency, and bitstring in a quantum error correction cycle.

12. The computer program product as recited in claim 9, wherein one or more of said nodes correspond to nodes that comprise one or more sub-nodes at a lower level of abstraction of said quantum stack.

13. The computer program product as recited in claim 12, wherein each of said one or more sub-nodes is associated with encoded information, wherein said encoded information comprises information regarding whether said sub-node can be expanded.

14. The computer program product as recited in claim 12, wherein settings in sub-node level i are consistent across level i-1.

15. The computer program product as recited in claim 14, wherein said settings are defined in a control panel.

16. The computer program product as recited in claim 9, wherein said plurality of layers of abstraction of said quantum stack comprise the following in the group consisting of: an application layer, an algorithm layer, a framework layer, an architecture layer, a control logic layer, a circuit layer, and a hardware layer.

17. A system, comprising:
a memory for storing a computer program for visualizing and manipulating quantum computations across multiple layers of abstraction of a quantum stack; and
a processor connected to said memory, wherein said processor is configured to execute program instructions of the computer program comprising:
receiving a quantum algorithm;
decomposing said quantum algorithm to nodes and edges between said nodes, wherein each of said nodes uses at least one layer of a plurality of layers of abstraction of said quantum stack;
displaying said nodes and said edges between said nodes; and
modifying an aspect of said quantum algorithm in response to editing a setting of a node.

18. The system as recited in claim 17, wherein said nodes correspond to computational tasks, wherein said edges define relationships between said nodes.

19. The system as recited in claim 17, wherein said nodes provide one or more of the following information in the group consisting of: a stage, an estimated time of computation, and a method of random sampling, wherein said edges provide one or more of the following information in the group consisting of: expected contribution to error or expectation value, measurement basis, logical dependency, and bitstring in a quantum error correction cycle.

20. The system as recited in claim 17, wherein one or more of said nodes correspond to nodes that comprise one or more sub-nodes at a lower level of abstraction of said quantum stack.
